(19) United States
(12) Patent Application Publication
(10) Pub. No.: US 2018/0017044 A1
(43) Pub. Date: Jan. 18, 2018

(54) Plasma Propulsion System Feedback Control

(71) Applicant: Wesley Faler, (US)

(72) Inventor: Wesley Faler, Dunedin, FL (US)

(21) Appl. No.: 15/652,227

(22) Filed: Jul. 17, 2017

Related U.S. Application Data
(60) Provisional application No. 62/363,143, filed on Jul. 15, 2016.

(51) Int. Cl. F03H 1/00; B64G 1/40; B64G 1/24; G05B 13/04; G05B 13/02

(52) U.S. Cl. CPC F03H 1/0012; G05B 13/041; G05B 13/0265; B64G 1/24; F03H 1/0031; B64G 1/405; B64G 2001/245

(57) ABSTRACT

Systems and methods can support a plasma propulsion system. The system may include a thrust head comprising a plasma generator and a thrust generator. A propellant handling assembly may be directly coupled to the thrust head. The propellant handling assembly may comprise a manifold and a plurality of valves. A propellant storage vessel may be directly coupled to the propellant handling assembly. A propulsion control module may be operable to receive inputs associated with the plasma propulsion system, generate control outputs associated with the plasma propulsion system, establish and train models relating the inputs and the control outputs, apply the inputs to the models to update the output parameters, and apply the output parameters to control the plasma propulsion system.

### RELATED APPLICATION

This application claims priority to U.S. Provisional Patent Application No. 62/363,143, filed Jul. 15, 2016 and entitled “Plasma Propulsion System Feedback Control.” The complete disclosure of the above-identified priority application is hereby fully incorporated herein by reference.

### BACKGROUND

Certain traditional plasma propulsion systems include a mass flow controller to regulate the flow rate of propellant vapor (such as iodine) using an internal feedback system sensitive to iodine vapor temperature and iodine vapor pressure. One prior feedback control system is configured to regulate the flow rate of the iodine vapor to the plasma generator.

There is at least one challenge for a feedback system sensing the plasma generator discharge current. Since the discharge current is often at high voltage, sensing the current generally requires bulky components, which is inconsistent with strong market demands for small products. This current flows through the electrodes that directly form the plasma.

Similarly, there is at least one challenge for a feedback system sensing the iodine vapor temperature. Since directly measuring a temperature of the iodine vapor requires sensors that must directly contact the vapor, the cost of these sensors is prohibitive and is inconsistent with market demands for low cost products.

There is also at least one challenge for a feedback system sensing the iodine vapor pressure. Directly measuring pressure of the iodine vapor requires sensors that must directly contact the vapor. The cost of these sensors is prohibitive and inconsistent with market demands for low cost products.

Accordingly, there is a need in the art for technology providing plasma thruster control technology operable to regulate actual thruster performance metrics in a holistic sense and not merely regulate a flow rate of iodine vapor within the thruster.

### SUMMARY

In certain example embodiments described herein, methods and systems can support a plasma propulsion system. The system may include a thrust head comprising a plasma generator and a thrust generator. A propellant handling assembly may be directly coupled to the thrust head. The propellant handling assembly may comprise a manifold and a plurality of valves. A propellant storage vessel may be directly coupled to the propellant handling assembly. A propulsion control module may be operable to receive inputs associated with the plasma propulsion system, generate control outputs associated with the plasma propulsion system, establish and train models relating the inputs and the control outputs, apply the inputs to the models to update the output parameters, and apply the output parameters to control the plasma propulsion system.

These and other aspects, objects, features, and advantages of the example embodiments will become apparent to those having ordinary skill in the art upon consideration of the following detailed description of illustrated example embodiments.

### BRIEF DESCRIPTION OF THE DRAWINGS

FIG. 1 is a block diagram illustrating a spacecraft plasma propulsion feedback system in accordance with one or more embodiments presented herein.

FIG. 2 is a block diagram illustrating a propulsion control layer associated with a spacecraft plasma propulsion system in accordance with one or more embodiments presented herein.

FIG. 3 illustrates an exploded view of a propellant handling assembly in accordance with one or more embodiments presented herein.

FIG. 4 illustrates a perspective view of a propellant handling assembly in accordance with one or more embodiments presented herein.

FIG. 5 illustrates an optical sensor within a thrust head of a thruster assembly in accordance with one or more embodiments presented herein.

FIG. 6 is a block flow diagram depicting a method for plasma thruster control in accordance with one or more embodiments presented herein.

FIG. 7 depicts a computing machine and a module in accordance with one or more embodiments presented herein.

### DETAILED DESCRIPTION OF EXAMPLE EMBODIMENTS

### Overview

In certain example embodiments described herein, methods and systems can support spacecraft plasma thruster technology using propellant material such as iodine. The plasma thruster may incorporate a propellant handling system that is tightly integrated into the thruster and may leverage a feedback controller sensitive to a variety of sensor and control inputs to achieve desired performance goals of thrust and/or specific impulse.

The technology presented herein can support plasma thruster control technology operable to regulate actual thruster performance metrics in a holistic sense through application of adaptive, machine learning techniques. The plasma thruster control technology can regulate the time-average thrust and/or specific-impulse of the thruster system leveraging mechanical integration of a propellant handling assembly within the thruster system. The plasma thruster control technology can vary flow rate and thruster settings to achieve various thrust and fuel economy goals. Tightly integrating the thruster plasma generator and thrust generation with the propellant storage vessel and the propellant handling system can substantially improve operating efficiencies and control dynamics associated with the plasma thruster.

The functionality of the various example embodiments will be explained in more detail in the following description, read in conjunction with the figures illustrating process flow. Turning now to the drawings, in which like numerals indicate like (but not necessarily identical) elements throughout the figures, example embodiments are described in detail.

### Example System Architectures

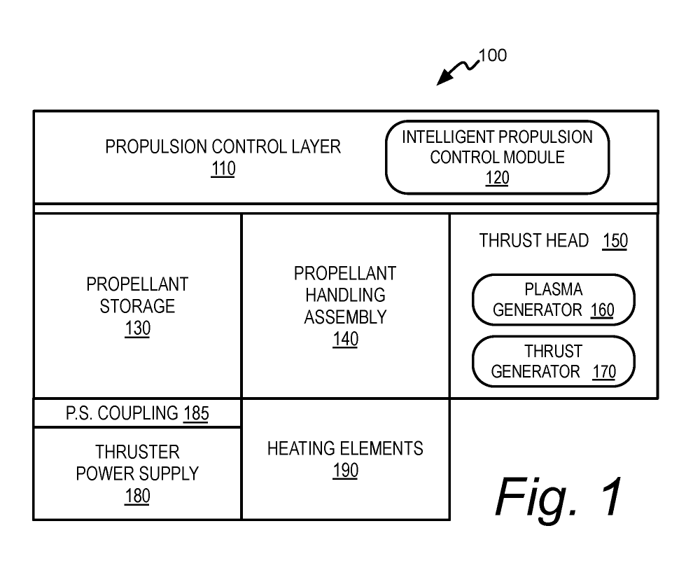

FIG. 1 is a block diagram illustrating a spacecraft plasma propulsion feedback system in accordance with one or more embodiments presented herein. A thruster assembly 100 may comprise a propulsion control layer 110. Material from propellant storage 130 may pass through a propellant handling assembly 140 for delivery to a thrust head 150. The thrust head 150 may comprise a plasma generator 160 and a thrust generator 170. One or more heating elements 190 may be used to provide thermal energy associated with various elements of the thruster assembly 100 such as the propellant storage 130, a propellant handling assembly 140, or thrust head 150. The heating elements can deliver the thermal energy into the thruster assembly 100 and/or generate the thermal energy within the thruster assembly 100. Operating power associated with the thruster assembly 100 may be provided from, and/or managed by, a thruster power supply 180. The thruster power supply 180 may be coupled to one or more other elements of the thruster assembly 100 by a power supply coupling 185. The propulsion control layer 110 may leverage one or more intelligent propulsion control modules 120.

The propellant storage 130 may be a storage vessel containing propellant material. According to certain embodiments, the propellant material may comprise solid iodine crystals, iodine vapor, and a buffer gas such as Argon. The storage vessel may be heated indirectly through spacecraft operations. The storage vessel may be heated directly through use of heating elements 190. The heating elements 190 may be positioned adjacent to the external faces of the storage vessel. A number of temperature sensors may be positioned on the external faces of the storage vessel. The thruster assembly 100 can produce thrust when fueled with a buffer gas alone.

The thruster power supply 180 may be positioned in close proximity to the propellant storage 130. Waste heat from the thruster power supply 180 can further warm the propellant storage 130. The power supply coupling 185 may comprise a thermally conductive, electrically insulating, mechanically flexible material. Such thermal materials may include thermal coupling compounds such as those for electronics cooling applications. The material associated with the power supply coupling 185 may be thermally conductive so as to transfer heat from the thruster power supply 180 to the propellant storage 130. The material associated with the power supply coupling 185 may be electrically insulating so as to preclude unwanted electrical discharge into the propellant storage 130. Mismatches in the heat expansion and/or deformation of the thruster power supply 180 and the propellant storage 130 may be accommodated by mechanically flexible of the material associated with the power supply coupling 185.

The vessel geometry associated with the propellant storage 130 may be any shape. The geometry need not be symmetric, cylindrical, cubical, spherical or any otherwise regularly shaped. The vessel geometry may be selected to best accommodate mission-specific structures, wires, cables, optics, and other devices.

The propellant material may comprise iodine. According to various other embodiments, the propellant material may comprise any of water, ionic liquids, Tin(II) Iodide, Iodine pentoxide, Zirconium(IV) iodide, Arsenic Iodide, Iodic acid, Tin(IV) Iodide, Iodine monobromide, Beryllium iodide, Xenon diflouride, Tetraiodomethane (aka. Carbon tetraiodide), Gallium(III) iodide, Lithium Iodide, Iodoform (aka Triiodomethane), Aluminum Triiodide, Arsenic trioxide, Lithium Iodide Hydrate, Lithium Bromide, Boron triiodide, Diiodomethane, Iodine pentafluoride, Iodine monochloride, Aluminum Bromide, Iodine trichloride, Iron(III) chloride, Diiodosilane, Zirconium(IV) chloride, Ammonium iodide, Aluminum Trichloride, Ammonium bromide, Tin(IV) Chloride, Sulfur, Tin(IV) Chloride pentahydrate, Ammonium chloride, and Napthlalene.

The propellant handling assembly 140 may be attached to the propellant storage 130. The propellant handling assembly 140 may comprise three or more valves situated upon a manifold block.

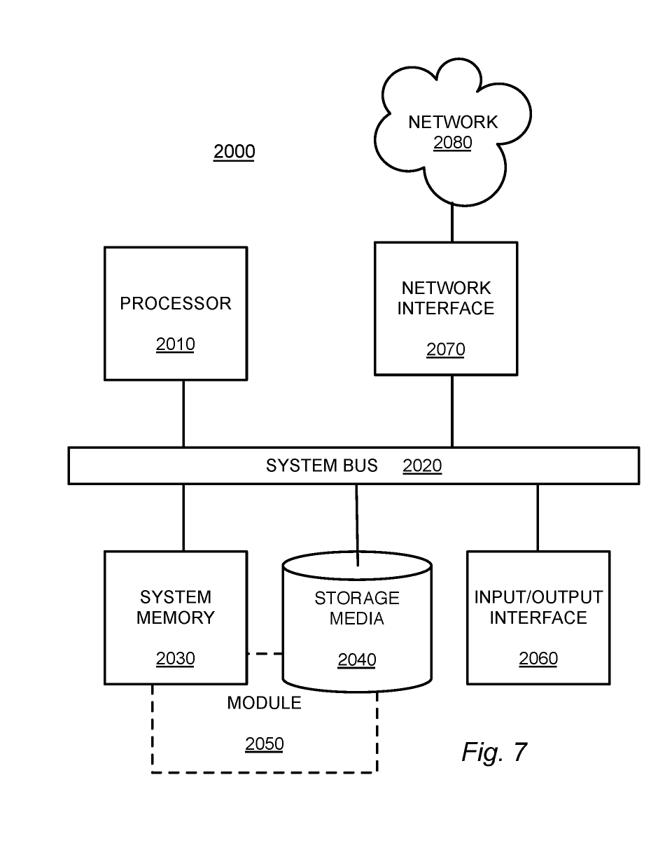

The propulsion control layer 110 or any other systems associated with the technology presented herein may comprise any type of computing machine such as, but not limited to, those discussed in more detail with respect to FIG. 7. Furthermore, any modules associated with any of these computing machines, such as the intelligent propulsion control module 120, or any other modules (scripts, web content, software, firmware, or hardware) associated with the technology presented herein may by any of the modules discussed in more detail with respect to FIG. 7. The devices and computing machines discussed herein may communicate with one another as well as other computer machines or communication systems over one or more networks. Such networks may include any type of data or communications links or network technology including any of the network technology discussed with respect to FIG. 7.

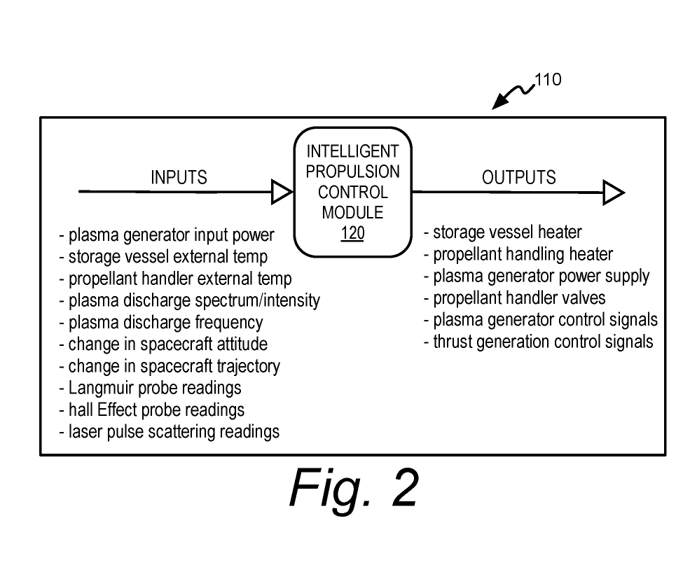

FIG. 2 is a block diagram illustrating a propulsion control layer 110 associated with a spacecraft plasma propulsion system in accordance with one or more embodiments presented herein. The propulsion control layer 110 may comprise one or more intelligent propulsion control modules 120. The intelligent propulsion control modules 120 can implement a feedback mechanism operable to control the operation of the thruster assembly 100. The feedback system associated with the intelligent propulsion control module 120 can regulate operation of the thruster assembly 100. The operation may be represent by time-average thrust, specific-impulse, or other such metrics.

The intelligent propulsion control module 120 can receive information from one or more control inputs. Examples of the inputs may include an input power associated with the plasma generator 160, an external temperature associated with the propellant storage 130 vessel, a temperature associated with the propellant handling assembly 140, a color/spectrum associated with the plasma discharge, an intensity associated with the plasma discharge, a change in the spacecraft attitude, a change in the spacecraft trajectory, Langmuir probe readings, Hall effect probe readings, laser pulse scattering readings, other such sensor or control inputs, and any combinations thereof.

The intelligent propulsion control module 120 can control one or more outputs. Examples of the outputs may include, control of a heater associated with the propellant storage 130 vessel, control of a heater associated with the propellant handling assembly 140, control of a power supply associated with the plasma generator 160, control of one or more valves associated with the propellant handling assembly 140, control signals associated with the plasma generator 160, control signals associated with the thrust generator 170, other such actuator or control outputs, and any combinations thereof.

The feedback control system associated with the intelligent propulsion control module 120 can receive any combination of the inputs and generate any combination of the outputs for operational control of the thruster assembly 100. The intelligent propulsion control module 120 can generate and maintain models for relationships between the inputs and the outputs so as to achieve the desired operational goals. A goal of the thruster assembly 100 may be to produce thrust at a desired level of force and/or specific-impulse. The intelligent propulsion control module 120 can adapt to maximize this goal under the constraints of available power, thruster wear over time, and varying levels of actuator effectiveness. Changing physical conditions may require the feedback system to alter response to inputs based upon learned relationships between inputs and outputs that temporally change. For example, it is very likely that feedback output values that generate a particular thrust level at the beginning of a mission will not generate the same thrust near the end of the mission even if propellant flow were held constant. For instance, high spark rates in the plasma generator can affect propellant flow into the thrust head. This may occur even where propellant is delivered at a constant rate by a mass flow controller. This may be due to compression of the propellant in the feed line between the mass flow controller and the thrust head. The intelligent and adaptive control mechanisms presented herein can substantially correct such limitations by considering feedback inputs in a more holistic manner than mere propellant flow. The intelligent propulsion control module 120 can generate and maintain models for the potentially very complex and non-linear relationships between the inputs and the outputs using machine learning techniques. The machine learning techniques may be trained. The machine learning techniques may be adapted over time.

One example input to the intelligent propulsion control module 120 may include the plasma generator input power. This is the rate of energy flow into the plasma generator's power supply. The plasma generator power supply may include step-up transformers, chopper circuits, capacitors, and inductors. These components can convert low voltage power into the high voltages and/or high frequencies needed for spark or RF plasma generation. The components may be non-linear and may form a pulsed network with substantial time delays in which the instantaneous output power cannot be known from the instantaneous input power. For instance plasma generator power supplies may operate at 20 KHz, which experience a high voltage burst every 50 microseconds. Sparks for forming plasma may last one microsecond or some other similar burst of time. When a spark occurs, some of the stored high voltage energy may be converted to useful plasma. The non-linear decoupling of input and output energy flow can prevent obtaining precise information about plasma formation from monitoring input power. An increase in input power can be caused by many low quality plasma-forming sparks, by few high quality sparks, or by any mixture of these two extremes. While plasma generator discharge current may be difficult to ascertain from monitoring the input power, useful feedback maybe achieved through the time-averaged, non-linear relationship between input power and common thruster performance metrics of thrust and specific-impulse. The plasma generator input power can affect the thrust and specific-impulse feedback goals.

One example input to the intelligent propulsion control module 120 may include external wall temperature of the storage vessel 130. This is the temperature of the vessel measured on an external face and not in contact with the contained propellant material. In an iodine example, the temperature of solid iodine governs the pressure of sublimated iodine vapor. However, directly measuring the temperature of iodine solid or vapor presents numerous engineering challenges. Rather, a general time-averaged, non-linear relationship exists between the properties of sublimated iodine vapor and the external temperature of its storage vessel. The storage vessel external wall temperature is not a direct measure of the temperature of contained solid or vaporous iodine. Such a reading is the time average temperature of a volume of storage vessel wall material. The wall material temperature is affected by physical interconnections to the spacecraft structure and by the physics of iodine/wall interaction within the storage vessel. The wall temperature may be most affected by iodine vapor when the vapor has low flow rate, exhibits viscous properties relative to the wall, and no solid iodine touches the wall. These conditions can increase the time in which any vapor molecule is in contact with the wall, during which thermal energy is transferred. The wall temperature may be least affected by iodine vapor when only solid iodine touches the wall, when vapor is fast flowing along the wall surface, or when net flow viscosity is low. These conditions can minimize the time in which a vapor molecule is in contact with the wall. A given temperature reading of the storage vessel's exterior wall can be caused by a wide range of physical conditions within the vessel, including a wide range of iodine vapor quantity, temperature, and pressure. The external wall temperature of the storage vessel 130 is an input that can affect the specific-impulse feedback goal.

One example input to the intelligent propulsion control module 120 may include and external temperature of the propellant handling assembly 140. This is the temperature on a surface of any part of the propellant management devices, including valves, pipes, and manifolds. As with the temperature on the storage vessel exterior wall, a given temperature reading can be caused by a wide range of physical conditions within the device, including a wide range of iodine vapor quantity, temperature, and pressure. Nevertheless, a general time-averaged, non-linear relationship may exist between the properties of sublimated iodine vapor and the external temperature of any device it passes through. The external temperature of the propellant handling assembly 140 is an input that can affect the specific-impulse feedback goal.

One example input to the intelligent propulsion control module 120 may include measuring the color, spectrum, and/or intensity of the plasma discharge. This is the photonic spectrum of energy released during a plasma discharge event. Plasma consists of charged particles that release photonic energy, sometimes in the human-visible spectrum, when accelerated, heated, or cooled. The spectrum of this energy can indicate the material comprising the plasma. For instance, a spark-based plasma generator running with very little propellant can contribute metal from its electrodes to the plasma, altering the visible color. Likewise, overly hot plasma can erode thruster wall material, again altering the visible color. The intensity of the spectral energy can denote the quantities of material present in the plasma. An optical sensing device may be used for measuring this input. These devices may have a geometry of a few millimeters square. These devices can convert optical data (spectrum and intensity) to digital signals accessible by feedback algorithms associated with the intelligent propulsion control module 120. When the plasma generator includes translucent or transparent sections, such devices may be readily mounted on the thruster body. Should electrical interference preclude this mounting a light guide (such as a fiber optical element) can bring the photons to the sensors mounted at a safe distance. This plasma discharge spectrum/intensity is an input that can affect the thrust and specific-impulse feedback goals.

One example input to the intelligent propulsion control module 120 may include the frequency of the plasma discharge. This is the frequency at which plasma formation occurs within the plasma generator. For spark-based plasma generators, plasma production may depend upon electrode spacing, vapor material, voltage, and vapor pressure. This dependency may be governed, for example, by the Paschen curve. Due to electrode erosion in a spark-based plasma generator, electrode spacing may not remain constant throughout the thruster lifespan. Likewise, hot plasma can erode wall material, altering the shape (volume) of the discharge chamber, and therefore the vapor pressure. These changing physical conditions can change the frequency at which plasma formation events occur. Plasma discharge frequency may be especially useful when combined with a history of plasma discharge color/spectrum and intensity to provide an estimate of electrode and wall (shape/volume) changes within the thruster. This frequency of the plasma discharge is an input that can affect the thrust and specific-impulse feedback goals.

One example input to the intelligent propulsion control module 120 may include a change in spacecraft attitude. Change in spacecraft heading over time can result as the thruster exerts a torque on the craft. Star trackers, gyroscopes, and accelerometers may be used to assess changes in craft attitude. While such devices may be external to the thruster assembly, the feedback system can accepts inputs of spacecraft attitude changes. Spacecraft attitude changes are inputs that can affect the thrust and specific-impulse feedback goals.

One example input to the intelligent propulsion control module 120 may include a change in spacecraft trajectory. Change in the spacecraft's projected path through space may result from thruster operation. Numerous types of navigation systems external to the thruster can provide the trajectory change information to support feedback controller operation. Change in spacecraft trajectory is an input that can affect the thrust and specific-impulse feedback goals.

One example input to the intelligent propulsion control module 120 may include Langmuir probe readings. Langmuir probe readings are a set of plasma properties derived from measurement with any number of Langmuir probe devices. Langmuir probes can position one or more electrodes into the plasma, measuring voltage and current on the probe electrodes in an effort to estimate plasma density and temperature. Various Langmuir probe device designs may be employed to provide information to guide the feedback controller. The Langmuir probe readings are inputs that can affect the specific-impulse feedback goal.

One example input to the intelligent propulsion control module 120 may include Hall Effect probe readings. This is the plasma property set derived from measurement with electrodes and magnetic fields as given by the Hall Effect. The Hall Effect dictates that as charged particles, such as plasma, move in a magnetic field, they generate an electric field. Measurements of this field can imply measures of plasma density, plasma net charge, and plasma velocity. Hall Effect probe readings are inputs that can affect the thrust and specific-impulse feedback goals.

One example input to the intelligent propulsion control module 120 may include Laser pulse scattering readings. These may include intensity of laser pulses that propagate through plasma and neutral gas. Plasmas can interact with laser pulses according to the Ponderomotive Force, absorbing laser energy as plasma particles are displaced. Due to leading and trailing edge effects, the interaction may be magnified when short laser pulses are used. Neutral vapor also absorbs laser energy, though at a different rate than plasma. A sensor can monitor the amount of laser light that traverses a region thought to contain plasma and/or neutral vapor. By comparing the sensor output to baseline vacuum conditions and calibration data, the amount of plasma and amount of neutral vapor can be ascertained. Laser pulse scattering is an input that can affect the specific-impulse feedback goal.

One example control output from the intelligent propulsion control module 120 may include the heating supplied to the storage vessel of the propellant storage 130. This may be the electrical power required to heat the storage vessel.

One example control output from the intelligent propulsion control module 120 may include the heating supply to the propellant handling assembly 140. This may be the electrical power required to heat the propellant handling assembly 140, including piping, manifold, and/or valves.

One example control output from the intelligent propulsion control module 120 may include the power supplied to the plasma generator 160. This may be the electrical power consumed to operate the plasma generator 160.

One example control output from the intelligent propulsion control module 120 may include the control signals to one or more valves within the propellant handling assembly 140. These signals can govern the open/close state of one or more valves within the propellant handling assembly 140.

One example control output from the intelligent propulsion control module 120 may include the control signals to the plasma generator 160. These signals can govern the attempted generation of plasma. These controls may include attempted spark formation frequency, RF frequency, and/or overall on/off state of the plasma generator 160.

One example control output from the intelligent propulsion control module 120 may include the control signals to thrust generator 170. These signals can govern the attempted acceleration of plasma, its constituents, and/or operation of a plasma neutralizer device. These controls may include electrostatic acceleration voltage selection, electromagnetic current selection, and/or neutralizer cathode voltage selection.

It should be appreciated that the feedback system associated with the intelligent propulsion control module 120 can couple operation of the entire thruster assembly 100 to performance-based metrics such as time-average thrust and/or specific-impulse. This holistic, end-to-end feedback control can provide significant benefits over simple regulation of propellant vapor flow rate.

It should be appreciated that machine-learning techniques associated with the intelligent propulsion control module 120 can learn and adapt to complex, nonlinear relationships among sensor inputs and control outputs. As explained by Wikipedia, a nonlinear system is a system in which the output is not directly proportional to the input. Nonlinear systems may appear chaotic, unpredictable or counterintuitive, contrasting with the much simpler linear systems. Typically, the behavior of a nonlinear system is described in mathematics by a nonlinear system of equations, which is a set of simultaneous equations in which the unknowns (or the unknown functions in the case of differential equations) appear as variables of a polynomial of degree higher than one or in the argument of a function which is not a polynomial of degree one. In other words, in a nonlinear system of equations, the equation(s) to be solved cannot be written as a linear combination of the unknown variables or functions that appear in them.

Consider the nonlinear example of the cosine function defining the system y=cos(x). The cosine function rises and falls as its input increases. Some changes in x will increase the output. The same change at a different starting point may decrease the output. Further, for any output value, there are multiple input values that can generate the output. Consider the non-cyclic function y=x². For a given change in x, the amount of change in y depends upon the initial value of x. As x declines and drops below zero, y increases. For any given output, y, there exist two possible inputs +/−sqrt(y) that can produce the desired output value.

Feedback mechanisms presented herein for control of the thruster assembly 100 may be highly nonlinear. Their measurements often aggregate multiple physical phenomena into a single value. The feedback control associated with the intelligent propulsion control module 120 can use an internal model of the thruster assembly 100. This internal model may be based upon the most likely physical system consistent with feedback observations. The internal model may be refined (adapted) throughout the lifetime of the thruster system. Such adaptation may account for the physical realities of thruster wear, power supply degradation due to radiation, and other physical processes typically experienced by plasma-based thrusters in a space environment. The machine learning approach presented herein can establish and maintain internal models that may not be well representable to humans. The stored information, relationships, and equations of the models may represent detailed realities of operation for the thruster assembly 100 without being readily deciphered by humans. For example, a neural network can implement system models as weighted connections between simulated neurons while not presenting any specific feature (such as weights, equations, or connections) that expressly defines aspects of the modeled system.

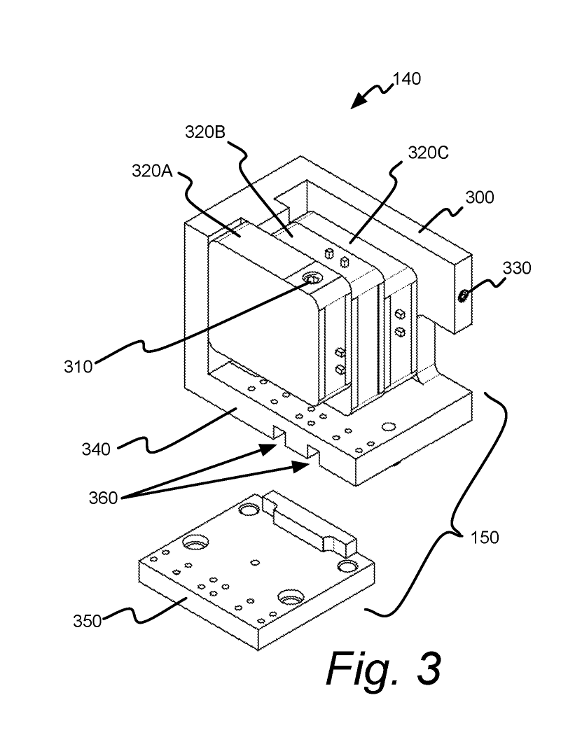

FIG. 3 illustrates an exploded view of a propellant handling assembly 140 in accordance with one or more embodiments presented herein. The propellant handling assembly 140 can comprise a manifold 300, a propellant inlet 310, valves 320A, 320B, 320C, a test port 330, and a thrust head 150. The thrust head 150 may comprise a thrust head first portion 340, a thrust head second portion 350, and one or more thruster exhaust ports 360. The valves 320A, 320B, 320C may be referred to collectively, or in general, as valves 320.

The propellant handling assembly 140 may be coupled to the storage vessel associated with propellant storage 130. The propellant handling assembly 140 may comprise a plurality of (for example, three) valves 320. The valves 320 may be piezo micro-valves. The valves 320 may be situated on the manifold 300. The manifold 300 can support the valves 320 in place and provide passageways for vapor transfer between valves 320. Heating elements on or within the manifold can heat the valves, the manifold structure, and/or the attached thrust head and storage vessel. The manifold may contain at least one test port 330 providing access to the gas flow path between valves. Each test port 330 may be used as part of a test regimen to verify valve and thruster operation.

The thruster assembly 100 may be designed such that the manifold 300 and the thrust head 150 make up a substantial portion of the thruster assembly 100. For example, the manifold 300 and the thrust head 150 may come together with a clamshell-style construction such that the manifold 300 is part of the thruster assembly 100 and is also part of the propellant handling assembly 140. This design can substantially reduce volume and mass, which may be especially beneficial for small spacecraft. This design can also eliminate the need for separate piping to move propellant from the handling system to a thrust head. Heaters and temperature sensors associated with the piping may also be avoided.

The valves 320 may comprise piezo micro-valves. Such valves 320 may contain lever arms. Force on such a lever arm holds the valve closed. Intense vibration experienced during rocket launch may move these level arms, opening the valve. The technology presented herein can comprise multiple valves 320 where at least one valve is rotated relative to other valves such that no single vibration direction can open all valves simultaneously. For example, the illustration depicts a stack of three valves 320 where the middle valve 320B may be rotated 90 degrees in the plane of the other two valves 320A, 320C. Accordingly, the lever arm associated with valve 320B has a direction of travel that may be rotated 90 degrees relative to that of the other valves 320A, 320C. The valves 320 may be positioned such that all valve arms do not share a common direction of travel. This design can substantially reduce the chance of unwanted vapor release during spacecraft launch and ground handling.

The materials making up the thruster assembly 100 components, including propellant storage 130, the propellant handling assembly 140, and the thrust head 150 may be metal, plastic, epoxy, or any other material known in the art to be minimally reactive with the propellant materials (for example, iodine vapor and iodine crystals) as well as the chosen buffer gas. Multiple layers of materials may be used, such that the propellant material contacts one type of material yet sensors and mechanical connections are made with another material on the exterior of a component. For instance, the storage vessel may be made of metal coated with plastic.

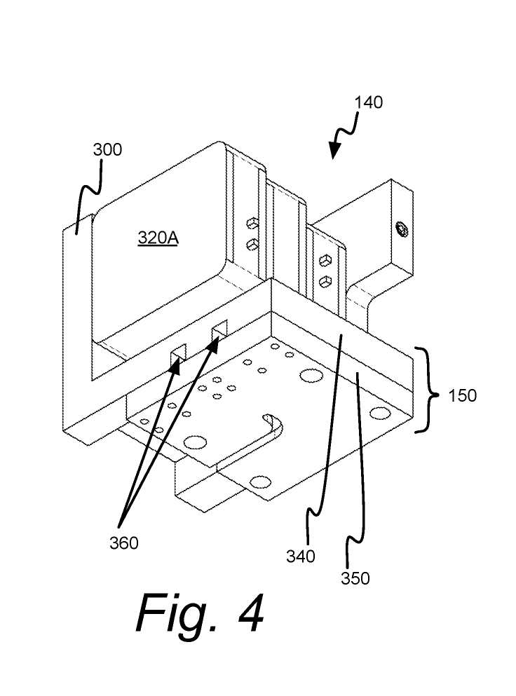

FIG. 4 illustrates a perspective view of a propellant handling assembly 140 in accordance with one or more embodiments presented herein. As presented with respect to FIG. 3, the propellant handling assembly 140 can comprise a manifold 300, a propellant inlet 310, valves 320A, 320B, 320C, a test port 330, and a thrust head 150.

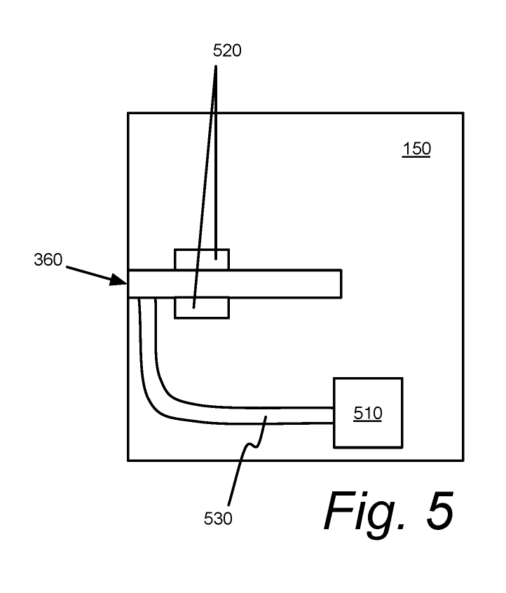

FIG. 5 illustrates an optical sensor 510 within a thrust head 150 of a thruster assembly 100 in accordance with one or more embodiments presented herein. A plasma generator 160 within the thrust head 150 may comprise plasma electrodes 520 for generated the plasma that is to be direct out through the thruster exhaust ports 360 to provide propulsion. A light guide 530 can couple optical radiation (photons) to an optical sensor 510. The optical sensor 510 may be embedded within, or mounted adjacent to, the thruster assembly 100.

The optical sensor 510 may be configured for measuring the color, spectrum, and/or intensity of the plasma discharge at or near the thruster exhaust ports 360. The plasma may release photonic energy, sometimes in the human-visible spectrum, when accelerated, heated, or cooled. The spectrum of this energy can indicate the material comprising the plasma. The optical sensor 510 can convert photonic qualities (spectrum and/or intensity) to digital signals accessible by feedback algorithms associated with the intelligent propulsion control module 120. Electrical interference concerns may dictate positioning the optical sensor 510 away from the plasma electrodes 520 and/or associated electronics. In such instances, the light guide 530 can couple photonic energy to from the plasma to the optical sensor 510 mounted at a safe distance. The light guide 530 may be a fiber optical element comprising glass, silica, and/or plastic.

### Example Processes

According to methods and blocks described in the embodiments presented herein, and, in alternative embodiments, certain blocks can be performed in a different order, in parallel with one another, omitted entirely, and/or combined between different example methods, and/or certain additional blocks can be performed, without departing from the scope and spirit of the invention. Accordingly, such alternative embodiments are included in the invention described herein.

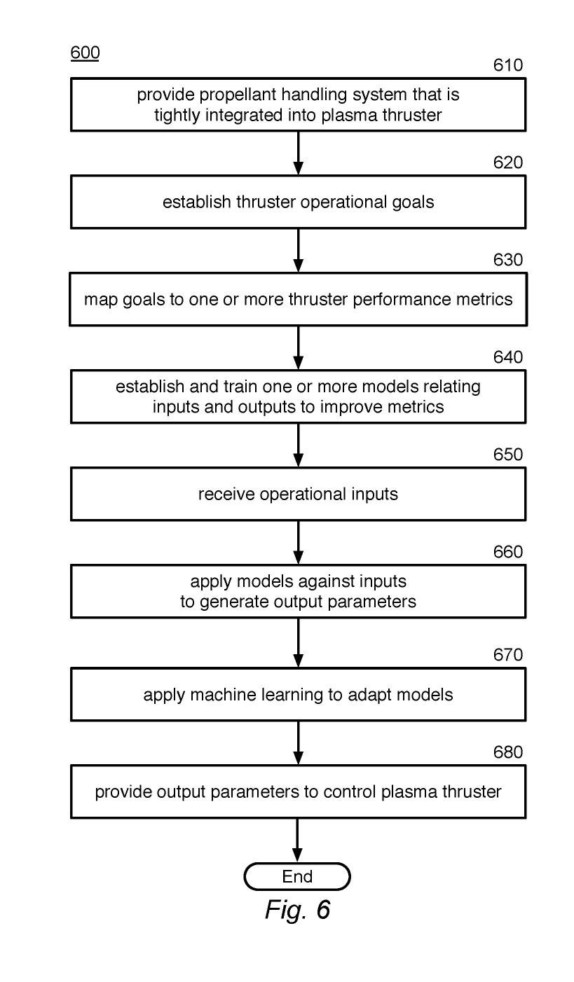

FIG. 6 is a block flow diagram depicting a method 600 for plasma thruster control in accordance with one or more embodiments presented herein.

In block 610, the thruster assembly 100 can provide a propellant handling system that is tightly integrated into plasma thruster.

In block 620, the intelligent propulsion control module 120 can establish thruster operational goals.

In block 630, the intelligent propulsion control module 120 can map goals to one or more thruster performance metrics. Such metrics may include, among others, time-average thrust and specific-impulse.

In block 640, the intelligent propulsion control module 120 can establish and train one or more models relating inputs and outputs to improve metrics.

In block 650, the intelligent propulsion control module 120 can receive operational inputs.

In block 660, the intelligent propulsion control module 120 can apply models against inputs to generate output parameters.

In block 670, the intelligent propulsion control module 120 can apply machine learning to adapt models

In block 680, the intelligent propulsion control module 120 can provide output parameters to control the plasma thruster.

### Example Systems

FIG. 7 depicts a computing machine 2000 and a module 2050 in accordance with one or more embodiments presented herein. The computing machine 2000 may correspond to any of the various computers, servers, mobile devices, embedded systems, or computing systems presented herein. The module 2050 may comprise one or more hardware or software elements configured to facilitate the computing machine 2000 in performing the various methods and processing functions presented herein. The computing machine 2000 may include various internal or attached components such as a processor 2010, system bus 2020, system memory 2030, storage media 2040, input/output interface 2060, and a network interface 2070 for communicating with a network 2080.

The computing machine 2000 may be implemented as a conventional computer system, an embedded controller, a laptop, a server, a mobile device, a smartphone, a set-top box, a kiosk, a vehicular information system, one more processors associated with a television, a customized machine, any other hardware platform, or any combination or multiplicity thereof. The computing machine 2000 may be a distributed system configured to function using multiple computing machines interconnected via a data network or bus system.

The processor 2010 may be configured to execute code or instructions to perform the operations and functionality described herein, manage request flow and address mappings, and to perform calculations and generate commands. The processor 2010 may be configured to monitor and control the operation of the components in the computing machine 2000. The processor 2010 may be a general purpose processor, a processor core, a multiprocessor, a reconfigurable processor, a microcontroller, a digital signal processor (“DSP”), an application specific integrated circuit (“ASIC”), a graphics processing unit (“GPU”), a field programmable gate array (“FPGA”), a programmable logic device (“PLD”), a controller, a state machine, gated logic, discrete hardware components, any other processing unit, or any combination or multiplicity thereof. The processor 2010 may be a single processing unit, multiple processing units, a single processing core, multiple processing cores, special purpose processing cores, co-processors, or any combination thereof. According to certain embodiments, the processor 2010 along with other components of the computing machine 2000 may be a virtualized computing machine executing within one or more other computing machines.

The system memory 2030 may include non-volatile memories such as read-only memory (“ROM”), programmable read-only memory (“PROM”), erasable programmable read-only memory (“EPROM”), flash memory, or any other device capable of storing program instructions or data with or without applied power. The system memory 2030 also may include volatile memories, such as random access memory (“RAM”), static random access memory (“SRAM”), dynamic random access memory (“DRAM”), and synchronous dynamic random access memory (“SDRAM”). Other types of RAM also may be used to implement the system memory 2030. The system memory 2030 may be implemented using a single memory module or multiple memory modules. While the system memory 2030 is depicted as being part of the computing machine 2000, one skilled in the art will recognize that the system memory 2030 may be separate from the computing machine 2000 without departing from the scope of the subject technology. It should also be appreciated that the system memory 2030 may include, or operate in conjunction with, a non-volatile storage device such as the storage media 2040.

The storage media 2040 may include a hard disk, a floppy disk, a compact disc read only memory (“CD-ROM”), a digital versatile disc (“DVD”), a Blu-ray disc, a magnetic tape, a flash memory, other non-volatile memory device, a solid sate drive (“SSD”), any magnetic storage device, any optical storage device, any electrical storage device, any semiconductor storage device, any physical-based storage device, any other data storage device, or any combination or multiplicity thereof. The storage media 2040 may store one or more operating systems, application programs and program modules such as module 2050, data, or any other information. The storage media 2040 may be part of, or connected to, the computing machine 2000. The storage media 2040 may also be part of one or more other computing machines that are in communication with the computing machine 2000 such as servers, database servers, cloud storage, network attached storage, and so forth.

The module 2050 may comprise one or more hardware or software elements configured to facilitate the computing machine 2000 with performing the various methods and processing functions presented herein. The module 2050 may include one or more sequences of instructions stored as software or firmware in association with the system memory 2030, the storage media 2040, or both. The storage media 2040 may therefore represent examples of machine or computer readable media on which instructions or code may be stored for execution by the processor 2010. Machine or computer readable media may generally refer to any medium or media used to provide instructions to the processor 2010. Such machine or computer readable media associated with the module 2050 may comprise a computer software product. It should be appreciated that a computer software product comprising the module 2050 may also be associated with one or more processes or methods for delivering the module 2050 to the computing machine 2000 via the network 2080, any signal-bearing medium, or any other communication or delivery technology. The module 2050 may also comprise hardware circuits or information for configuring hardware circuits such as microcode or configuration information for an FPGA or other PLD.

The input/output (“I/O”) interface 2060 may be configured to couple to one or more external devices, to receive data from the one or more external devices, and to send data to the one or more external devices. Such external devices along with the various internal devices may also be known as peripheral devices. The I/O interface 2060 may include both electrical and physical connections for operably coupling the various peripheral devices to the computing machine 2000 or the processor 2010. The I/O interface 2060 may be configured to communicate data, addresses, and control signals between the peripheral devices, the computing machine 2000, or the processor 2010. The I/O interface 2060 may be configured to implement any standard interface, such as small computer system interface (“SCSI”), serial-attached SCSI (“SAS”), fiber channel, peripheral component interconnect (“PCP”), PCI express (PCIe), serial bus, parallel bus, advanced technology attachment (“ATA”), serial ATA (“SATA”), universal serial bus (“USB”), Thunderbolt, FireWire, various video buses, and the like. The I/O interface 2060 may be configured to implement only one interface or bus technology. Alternatively, the I/O interface 2060 may be configured to implement multiple interfaces or bus technologies. The I/O interface 2060 may be configured as part of, all of, or to operate in conjunction with, the system bus 2020. The I/O interface 2060 may include one or more buffers for buffering transmissions between one or more external devices, internal devices, the computing machine 2000, or the processor 2010.

The I/O interface 2060 may couple the computing machine 2000 to various input devices including mice, touch-screens, scanners, biometric readers, electronic digitizers, sensors, receivers, touchpads, trackballs, cameras, microphones, keyboards, any other pointing devices, or any combinations thereof. The I/O interface 2060 may couple the computing machine 2000 to various output devices including video displays, speakers, printers, projectors, tactile feedback devices, automation control, robotic components, actuators, motors, fans, solenoids, valves, pumps, transmitters, signal emitters, lights, and so forth.

The computing machine 2000 may operate in a networked environment using logical connections through the network interface 2070 to one or more other systems or computing machines across the network 2080. The network 2080 may include wide area networks (“WAN”), local area networks (“LAN”), intranets, the Internet, wireless access networks, wired networks, mobile networks, telephone networks, optical networks, or combinations thereof. The network 2080 may be packet switched, circuit switched, of any topology, and may use any communication protocol. Communication links within the network 2080 may involve various digital or an analog communication media such as fiber optic cables, free-space optics, waveguides, electrical conductors, wireless links, antennas, radio-frequency communications, and so forth.

The processor 2010 may be connected to the other elements of the computing machine 2000 or the various peripherals discussed herein through the system bus 2020. It should be appreciated that the system bus 2020 may be within the processor 2010, outside the processor 2010, or both. According to some embodiments, any of the processor 2010, the other elements of the computing machine 2000, or the various peripherals discussed herein may be integrated into a single device such as a system on chip (“SOC”), system on package (“SOP”), or ASIC device.

In situations in which the systems discussed here collect personal information about users, or may make use of personal information, the users may be provided with a opportunity to control whether programs or features collect user information (e.g., information about a user's social network, social actions or activities, profession, a user's preferences, or a user's current location), or to control whether and/or how to receive content from the content server that may be more relevant to the user. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information is collected about the user and used by a content server.

One or more aspects of embodiments may comprise a computer program that embodies the functions described and illustrated herein, wherein the computer program is implemented in a computer system that comprises instructions stored in a machine-readable medium and a processor that executes the instructions. However, it should be apparent that there could be many different ways of implementing embodiments in computer programming, and the invention should not be construed as limited to any one set of computer program instructions. Further, a skilled programmer would be able to write such a computer program to implement an embodiment of the disclosed invention based on the appended flow charts and associated description in the application text. Therefore, disclosure of a particular set of program code instructions is not considered necessary for an adequate understanding of how to make and use the invention. Further, those skilled in the art will appreciate that one or more aspects of the invention described herein may be performed by hardware, software, or a combination thereof, as may be embodied in one or more computing systems. Moreover, any reference to an act being performed by a computer should not be construed as being performed by a single computer as more than one computer may perform the act.

The example embodiments described herein can be used with computer hardware and software that perform the methods and processing functions described previously. The systems, methods, and procedures described herein can be embodied in a programmable computer, computer-executable software, or digital circuitry. The software can be stored on computer-readable media. For example, computer-readable media can include a floppy disk, RAM, ROM, hard disk, removable media, flash memory, memory stick, optical media, magneto-optical media, CD-ROM, etc. Digital circuitry can include integrated circuits, gate arrays, building block logic, field programmable gate arrays (“FPGA”), etc.

The example systems, methods, and acts described in the embodiments presented previously are illustrative, and, in alternative embodiments, certain acts can be performed in a different order, in parallel with one another, omitted entirely, and/or combined between different example embodiments, and/or certain additional acts can be performed, without departing from the scope and spirit of embodiments of the invention. Accordingly, such alternative embodiments are included in the inventions described herein.

Although specific embodiments have been described above in detail, the description is merely for purposes of illustration. It should be appreciated, therefore, that many aspects described above are not intended as required or essential elements unless explicitly stated otherwise. Modifications of, and equivalent components or acts corresponding to, the disclosed aspects of the example embodiments, in addition to those described above, can be made by a person of ordinary skill in the art, having the benefit of the present disclosure, without departing from the spirit and scope of the invention defined in the following claims, the scope of which is to be accorded the broadest interpretation so as to encompass such modifications and equivalent structures.

What is claimed is:

1. A plasma propulsion system, comprising:
a thrust head comprising a plasma generator and a thrust generator;
a propellant handling assembly directly coupled to the thrust head, wherein the propellant handling assembly comprises a manifold and a plurality of valves;
a propellant storage vessel directly coupled to the propellant handling assembly; and
a propulsion control module operable to:
receive inputs associated with the plasma propulsion system,
generate control outputs associated with the plasma propulsion system,
establish and train one or more models relating the inputs and the control outputs,
apply received inputs to the one or more models to update the generated output parameters, and
apply the generated output parameters to control the plasma propulsion system.

2. The plasma propulsion system of claim 1, wherein the one or more models seek to regulate performance metrics associated with the plasma propulsion system.

3. The plasma propulsion system of claim 1, wherein the plurality of valves comprise piezo micro-valves.

4. The plasma propulsion system of claim 1, wherein the manifold comprises a test port to access to a flow path between the plurality of valves.

5. The plasma propulsion system of claim 1, further comprising a heating element associated with the manifold.

6. The plasma propulsion system of claim 1, wherein training the one or more models comprises applying machine learning techniques.

7. The plasma propulsion system of claim 1, where a first one the plurality of valves is oriented in a substantially orthogonal fashion to a second one of the plurality of valves.

8. The plasma propulsion system of claim 1, wherein the control outputs comprise thrust generator control signals.

9. The plasma propulsion system of claim 1, wherein the inputs comprise an optical sensor operable to measure a plasma discharge spectrum.

10. The plasma propulsion system of claim 1, wherein the inputs comprise one or both of an attitude associated with a spacecraft and a trajectory associated with the spacecraft, wherein the spacecraft is associated with the plasma propulsion system.

11. A method for plasma propulsion, comprising:
providing a plasma thruster, wherein the plasma thruster comprises a thrust head, a propellant handling assembly directly coupled to the thrust head, and a propellant storage vessel directly coupled to the propellant handling assembly;
establishing operational goals associated with the plasma thruster;
mapping the operational goals to one or more performance metrics associated with the plasma thruster;
receiving operational inputs associated with the plasma thruster;
establishing and training one or more models relating the operational inputs to output parameters to improve the one or more performance metrics;
applying the operational inputs to the one or more models to generate the output parameters; and
controlling the plasma thruster in response to the output parameters.
